(19) United States
(12) Patent Application Publication
(10) Pub. No.: US 2007/0067197 A1
(43) Pub. Date: Mar. 22, 2007

(54) Efficiently routing customer inquiries created with a self-service application

(75) Inventor: Robert R. Bushey, Cedar Park, TX (US)

Correspondence Address: GREENBLUM & BERNSTEIN, P.L.C., 1950 ROLAND CLARKE PLACE, RESTON, VA, 20191, US

(73) Assignee: SBC Knowledge Ventures, L.P., Reno, NV (US)

(21) Appl. No.: 11/227,557

(22) Filed: Sep. 16, 2005

(51) Int. Cl. G06F 9/46

(52) U.S. Cl. 705/8

(57) ABSTRACT

An electronic customer inquiry is properly routed, even when multiple salient terms are included in the electronic inquiry. Initially salient terms aee extracted from the electronic inquiry. Then each salient term is linked with at least one Action-Object and a probability that the Action-Object matches a purpose of the electronic inquiry. For each Action-Object, the probabilities linked with the salient terms are summed and an Action-Object with the highest summed probability is selected. The best Action-Object is assigned to the electronic inquiry, and the electronic inquiry is routed in accordance with the assigned Action-Object. Thus, correct routing occurs when multiple salient terms are found, and/or multiple Action-Objects are linked to the salient terms.

### BACKGROUND OF THE INVENTION

1. Field of the Invention

The present invention relates to electronic inquiries to an enterprise. More particularly, the present invention relates to efficiently routing the customer inquiries within the enterprise.

2. Background Information

Customers often interact with an enterprise's web site to obtain information about the enterprise. Similarly, customers frequently interact with the web site to ask questions about and/or report problems about products or services of the enterprise. One way for the customer to inquire is via email. Another option is to fill out a form on a web page and then submit the form to the enterprise.

When companies receive a large volume of inquiries (e.g., email), correct routing of the inquiries becomes important. Misdirected email means that the email was sent to the wrong agent and that agent must read the email and then forward it to the correct agent—thus costing money. Moreover, the additional time to process the email slows the company's response to the email.

Some current email routing approaches rely upon the subject line of the email. Such an approach has been observed to result in a 19.3% misdirect rate. A company handling 93,000 email each month would have 17,900 email being handled twice. Other current approaches route email to a general mailbox when multiple keywords or found, also resulting in double handling. Still other current approaches create a precedence order so that when multiple results are found, routing is simply based upon the highest priority rule. Misdirected email causes lower customer satisfaction and increased costs.

To solve the above-described problems, enterprise automated email routing is provided.

### BRIEF DESCRIPTION OF THE DRAWINGS

FIG. 1 shows an exemplary general computer system that includes a set of instructions for performing Action-Object processing;

FIG. 2 shows an exemplary process for determining a best Action-Object when multiple salient terms are included in an inquiry, according to an aspect of the present invention; and

FIG. 3 shows an exemplary process for revising a vague Action-Object, according to an aspect of the present invention.

### DETAILED DESCRIPTION

In view of the foregoing, the present invention, through one or more of its various aspects, embodiments and/or specific features or sub-components, is thus intended to bring out one or more of the advantages as specifically noted below.

In one aspect of the present invention, a computer readable medium stores a program for determining a goal of an electronic customer inquiry when multiple salient terms are included in the electronic inquiry. The medium includes an Action-Object code segment that links each salient term with at least one Action-Object and a rating that reflects how well the Action-Object matches the goal of the electronic inquiry. The medium also includes an analyzing code segment that analyzes, for each Action-Object, the ratings linked with the salient terms. The medium further includes a selecting code segment that selects a best Action-Object that best matches the goal, based upon the ratings; and an assigning code segment that assigns the selected best Action-Object to the electronic inquiry.

In one aspect, the medium further includes a locating code segment that extracts each salient term from the electronic inquiry; and a routing code segment that routes the electronic inquiry in accordance with the assigned Action-Object.

In another aspect, a reply generator generates a reply to the electronic inquiry based upon the assigned Action-object.

The medium can also include a form generator that provides an electronic form for the customer to complete, the form, when including customer input, comprising the electronic inquiry. The form generator can provide the form to the customer via the Web.

In another aspect, a method is provided for routing an electronic customer inquiry when multiple salient terms are included in the electronic inquiry. The method includes locating salient terms from the electronic inquiry; and linking each salient term with at least one Action-Object and a probability that the Action-Object matches a purpose of the electronic inquiry. The method also includes summing, for each Action-Object, the probabilities linked with the salient terms; selecting a best Action-Object with the highest summed probability; assigning the best Action-Object to the electronic inquiry; and routing the electronic inquiry in accordance with the assigned Action-Object. Thus, when multiple salient terms are found, and/or multiple Action-Objects are linked to the salient terms, correct routing occurs.

The method can also include creating a table that links salient terms with Action-Objects and probabilities, prior to locating and linking. The method can also include generating a reply to the electronic inquiry based upon the assigned Action-object, and/or providing a form for the customer to complete, the completed form comprising the electronic inquiry.

A tag can be associated with the electronic inquiry, the tag representing the assigned Action-Object. In one embodiment, the tag is not visible to the customer.

In still another aspect, a method is provided for correctly routing a written electronic customer inquiry when the inquiry does not include enough information for correct routing. The method includes defining vague Action-Objects; associating each vague Action-Object with at least one follow-up question to help clarify a customer's intent; and presenting the clarifying question to the customer when the inquiry is linked with a vague Action-Object.

The method can also include presenting the customer with an electronic form to complete, in order to create the inquiry; and presenting the clarifying question to the customer when the customer is filling out the form to help the customer provide information that is specific enough to correctly route the inquiry. In one embodiment, the electronic form is presented via the internet.

A tag representing the vague Action-Object can be associated with the form when the customer is creating the inquiry. Preferably, the tag is not visible to the customer. When updating the tag as further clarifying information is received, the customer is unaware of the updated tag. Updating the tag can include linking the inquiry with a new Action-Object in response to receiving a response to the clarifying question. In one embodiment, presenting the clarifying question includes sending an email to the customer when the customer has already submitted the inquiry.

In yet another aspect, a computer readable medium stores a program for elucidating a purpose of an electronic customer inquiry when the inquiry does not include enough information for correct routing within an enterprise. The medium includes a vague Action-Object table that links each vague Action-Object with a follow-up question(s) to help clarify the purpose of the electronic customer inquiry. The medium also includes an assignment code segment that assigns a vague Action-Object to the electronic customer inquiry based upon analysis of terminology included in the inquiry and a look-up in the vague Action-Object table.

The medium can also include an updated Action-Object code segment that links the inquiry with a new Action-Object in response to receiving a response to the follow-up question(s) linked to the assigned vague Action-Object.

The medium can also include an electronic form presenting code segment that present an electronic form to the customer for the customer to fill out, and a questioning code segment that presents to the customer the follow-up question(s) linked to the assigned vague Action-Object before the customer finishes filling out the form.

The medium can further include a tagging code segment that associates a tag with the vague Action-Object when the customer is creating the inquiry, the tag not being visible to the customer.

In still another aspect, a system is provided for routing an electronic customer inquiry when multiple salient terms are included in the electronic inquiry. The system includes an inquiry processor that extracts salient terms from the electronic inquiry; and an Action-Object processor that links each salient term with at least one Action-Object and a probability that the Action-Object matches a purpose of the electronic inquiry. The system further includes an adder that sums, for each Action-Object, the probabilities linked with the salient terms; and a selector that selects a best Action-Object with the highest summed probability. The system also includes a designator that assigns the best Action-Object to the electronic inquiry; and a router that routes the electronic inquiry in accordance with the assigned Action-Object. Thus, when multiple salient terms are found, and/or multiple Action-Objects are linked to the salient terms, correct routing occurs.

The present invention focuses on the capability of capturing a customer's task (via Action-Objects) while the customer is in a web page or in a customer's email. The information is then used for routing the email (or the customer's request) to the correct destination. According to an aspect of the present invention, a customer types in their task either into an email or at a web page of an enterprise. The application assigns the correct Action-Object, based on the methodology described below. The Action-Object is then used for correctly routing the inquiry.

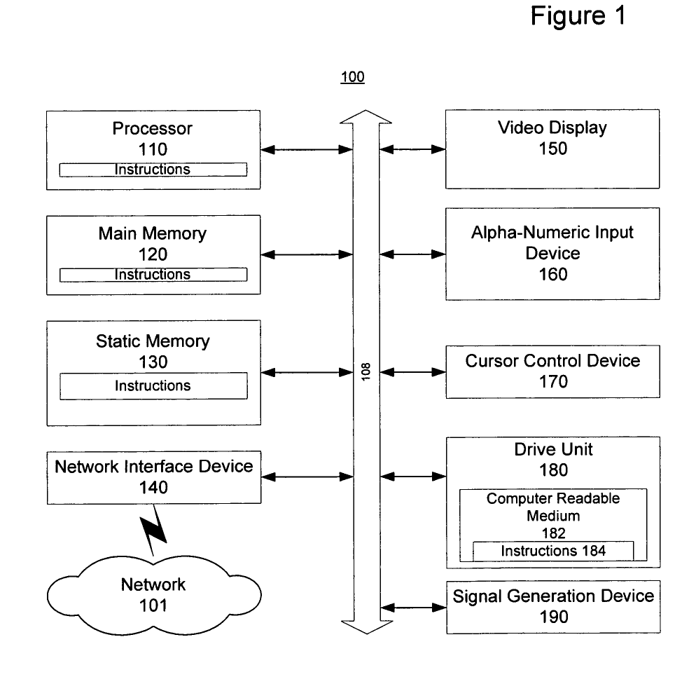

Referring to FIG. 1, a description is now provided of an illustrative embodiment of a general computer system 100, on which the enterprise automated email router can be implemented. The computer system 100 can include a set of instructions that can be executed to cause the computer system 100 to perform any one or more of the methods or computer based functions disclosed herein. The computer system 100 may operate as a standalone device or may be connected, e.g., using a network 101, to other computer systems or peripheral devices.

In a networked deployment, the computer system may operate in the capacity of a server or as a client user computer in a server-client user network environment, or as a peer computer system in a peer-to-peer (or distributed) network environment. The computer system 100 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 may include a processor 110, e.g., a central processing unit (CPU), a graphics processing unit (GPU), or both. Moreover, the computer system 100 can include a main memory 120 and a static memory 130 that can communicate with each other via a bus 108. As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard, and a cursor control device 170, such as a mouse. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g. software, can be embedded. Further, the instructions 184 may embody one or more of the methods or logic as described herein. In a particular embodiment, the instructions 184 may reside completely, or at least partially, within the main memory 120, the static memory 130, and/or within the processor 110 during execution by the computer system 100. The main memory 120 and the processor 110 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 182 that includes instructions 184 or receives and executes instructions 184 responsive to a propagated signal, so that a device connected to a network 101 can communicate voice, video or data over the network 101. Further, the instructions 184 may be transmitted or received over the network 101 via the network interface device 140.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

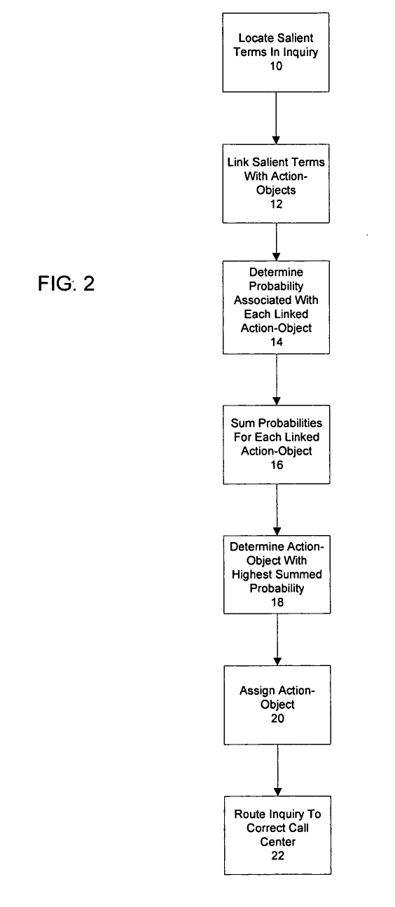

Using a general computer system as shown in FIG. 1, an email routing system may be provided. In order to determine appropriate Action-Objects, a probability analysis may be implemented. For example, if a customer email (or web page form) is created stating “I want to pay my bill”, the salient terms are first identified. Referring to FIG. 2, step 10 shows the extraction of salient terms. In this example, the two salient terms from the customer's task are “PAY” and “BILL.” A previously defined table that links salient terms with probabilities is then consulted to determine the proper Action-Object. Table 1 shows such an exemplary table, which the enterprise typically creates prior to performing analysis.

TABLE 1

| | Action-Objects | | |
|---|---|---|---|
| | | | INQUIRE- |
| SALIENT TERMS | PAY-BILL | VAGUE-BILL | BALANCE |
| “PAY” | 90% | 0% | 0% |
| “BILL” | 80% | 100% | 70% |
| SUM | 170% | 100% | 70% |

Each salient term is linked with Action-Objects, based upon a lookup in the table (step 12 ). The probability for each linked Action-Object is then determined at step 14. In Table 1, it can be seen that for the salient term “PAY,” the Action-Object Pay-Bill is associated with a 90% probability, whereas the Action-Objects of Vague-Bill and Inquire Balance are each associated with a 0% probability of being the correct Action-Object. Similarly, it can be seen for the salient term “BILL,” the Action-Object Pay-Bill is associated with an 80% probability of being the correct Action-Object, the Action-Object Vague-Bill is associated with a 100% probability of being the correct Action-Object, and the Action-Object Inquire Balance is associated with a 70% probability of being the correct Action-Object.

At step 16, probabilities for each linked Action-object are totaled. In this example, summing each Action-Object column yields the totals 170% for Pay-Bill; 100% for Vague-Bill; and 70% for Inquire-Balance. The Action-Object with the highest total probability is determined at step 18. According to this aspect of the present invention, the highest sum correlates to the Action-Object that will be selected. In this example, Pay-Bill is assigned to the inquiry (step 20). The email is then routed in accordance with the Action-Object: Pay-Bill at step 22. In one embodiment, the Action-Objects are specific enough so that an automatic email can be generated in response to the customer's inquiry. Thus, the rapid response will further increase customer satisfaction.

Consequently, when multiple salient terms are found, and/or multiple Action-Objects are determined, proper routing still occurs.

According to another aspect of the present invention, vague Action-Objects can be defined. An example of a vague Action-Object is Vague-Bill. Such a vague Action-Object could be associated with a follow-up question(s) to help clarify the customer's intent. For example, the inquiry “I have a question about my bill” could be linked with a Vague-Bill Action-Object. In this case, a follow-up question linked with Vague-Bill could be “Are you concerned with a specific item on your bill, or are you inquiring about the total amount of the bill?”

In one embodiment, the clarifying question is asked as the customer is filling out the form on the web page. Thus, the customer is coached to provide information that is specific enough to correctly route the inquiry. In this case, an Action-Object could be associated with the email being created as a tag that the customer does not necessarily see. As further clarifying information is received, the tag could be updated, without the customer even being aware of the tag, rather than modifying the information being filled-in by the user. In other words, a new Action-Object can be linked with the email in response to an answer to the clarifying question(s). The updated tag reflects the new Action-Object.

In this embodiment, the processing occurs as the customer is entering information, rather than after the customer selects “send.” In another embodiment in which the customer has already sent an email, the enterprise could email the follow-up question(s) to the user, when receiving the customer's email.

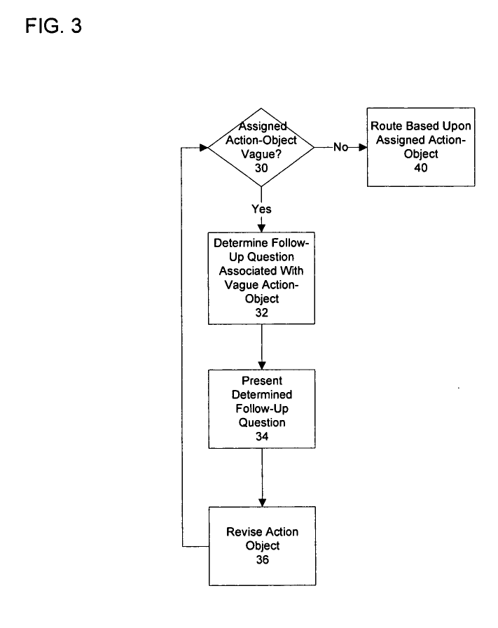

Referring to FIG. 3, an assigned Action-Object is examined to determine whether it is a vague Action-Object at step 30. If so, at step 32 a follow-up question associated with the vague Action-Object is determined. At step 34, the follow-up question is presented to the customer. Based upon a response to the follow-up question, at step 36 the Action-Object is updated. Processing then returns to step 30. If the Action-Object is determined not to be vague, at step 40 routing occurs based upon the assigned Action-Object. Although not shown in FIG. 3, if the Action-Object is still determined to be vague, even after updating, routing to a default location could occur, to prevent the customer from being subjected to too many automatic follow-up questions. In one embodiment, routing to the default location only occurs after a predetermined number of follow-up questions have been posed to the customer.

Thus, aspects of the present invention permit accurate routing of customer generated inquiries by assigning appropriate Action-Objects. The correct Action-Objects are assigned, even when multiple salient terms are included in the customer's inquiry. Moreover, if the inquiry is too vague for accurate routing, a vague Action-Object can be assigned to the inquiry. The vague Action-Object is linked with clarifying questions, which are used to determine the customer's intent.

Although the present specification describes components and functions that may be implemented in particular embodiments with reference to particular standards and protocols, the invention is not limited to such standards and protocols. Each of the standards, protocols and languages represent examples of the state of the art. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

What is claimed is:

1. A computer readable medium storing a program for determining a goal of an electronic customer inquiry when a plurality of salient terms are included in the electronic inquiry, the medium comprising:
an Action-Object code segment that links each salient term, of the plurality of salient terms, with at least one Action-Object and a rating that reflects how well the Action-Object matches the goal of the electronic inquiry;
an analyzing code segment that analyzes, for each Action-Object, the ratings linked with the salient terms;
a selecting code segment that selects a best Action-Object that best matches the goal, based upon the ratings; and
an assigning code segment that assigns the selected best Action-Object to the electronic inquiry.

2. The medium of claim 1, further comprising:
a locating code segment that extracts each salient term from the electronic inquiry; and
a routing code segment that routes the electronic inquiry in accordance with the assigned Action-Object.

3. The medium of claim 1, further comprising a reply generator that generates a reply to the electronic inquiry based upon the assigned Action-object.

4. The medium of claim 1, further comprising a form generator that provides an electronic form for the customer to complete, the form, when including customer input, comprising the electronic inquiry.

5. The medium of claim 4, in which the form generator provides the form to the customer via the Web.

6. A method for routing an electronic customer inquiry when multiple salient terms are included in the electronic inquiry, the method comprising:
locating salient terms from the electronic inquiry;
linking each salient term with at least one Action-Object and a probability that the Action-Object matches a purpose of the electronic inquiry;
summing, for each Action-Object, the probabilities linked with the salient terms;
selecting a best Action-Object with the highest summed probability;
assigning the best Action-Object to the electronic inquiry; and
routing the electronic inquiry in accordance with the assigned Action-Object,
wherein when multiple salient terms are found, and/or multiple Action-Objects are linked to the salient terms, correct routing occurs.

7. The method of claim 6, further comprising creating a table that links salient terms with Action-Objects and probabilities, prior to locating and linking.

8. The method of claim 6, further comprising generating a reply to the electronic inquiry based upon the assigned Action-object.

9. The method of claim 6, further comprising providing a form for the customer to complete, the completed form comprising the electronic inquiry.

10. The method of claim 9, further comprising associating a tag, representing the assigned Action-Object, with the electronic inquiry.

11. The method of claim 10, wherein the tag is not visible to the customer.

12. A method for correctly routing a written electronic customer inquiry when the inquiry does not include enough information for correct routing, the method comprising:
defining vague Action-Objects;
associating each vague Action-Object with at least one follow-up question to help clarify a customer's intent; and
presenting the clarifying question to the customer when the inquiry is linked with a vague Action-Object.

13. The method of claim 12, further comprising presenting the customer with an electronic form to complete, in order to create the inquiry; and
presenting the clarifying question to the customer when the customer is filling out the form to help the customer provide information that is specific enough to correctly route the inquiry.

14. The method of claim 13, in which the electronic form is presented via the internet.

15. The method of claim 12, further comprising associating a tag representing the vague Action-Object with the form when the customer is creating the inquiry, the tag not being visible to the customer.

16. The method of claim 15, further comprising updating the tag as further clarifying information is received, wherein, the customer is unaware of the updated tag.

17. The method of claim 16, in which updating the tag further comprises linking the inquiry with a new Action-Object in response to receiving a response to the clarifying question.

18. The method of claim 12, in which presenting the clarifying question further comprises sending an email to the customer when the customer has already submitted the inquiry.

19. A computer readable medium storing a program for elucidating a purpose of an electronic customer inquiry when the inquiry does not include enough information for correct routing within an enterprise, the medium comprising:
a vague Action-Object table that links each vague Action-Object with at least one follow-up question to help clarify the purpose of the electronic customer inquiry; and
an assignment code segment that assigns a vague Action-Object to the electronic customer inquiry based upon analysis of terminology included in the inquiry and a look-up in the vague Action-Object table.

20. The medium of claim 19, further comprising an updated Action-Object code segment that links the inquiry with a new Action-Object in response to receiving a response to the at least one follow-up question linked to the assigned vague Action-Object.

21. The medium of claim 19, further comprising an electronic form presenting code segment that present an electronic form to the customer for the customer to fill out, and
a questioning code segment that presents to the customer the at least one follow-up question linked to the assigned vague Action-Object before the customer finishes filling out the form.

22. The medium of claim 19, further comprising a tagging code segment that associates a tag with the vague Action-Object when the customer is creating the inquiry, the tag not being visible to the customer.

23. A system for routing an electronic customer inquiry when multiple salient terms are included in the electronic inquiry, the system comprising:
an inquiry processor that extracts salient terms from the electronic inquiry;
an Action-Object processor that links each salient term with at least one Action-Object and a probability that the Action-Object matches a purpose of the electronic inquiry;
an adder that sums, for each Action-Object, the probabilities linked with the salient terms;
a selector that selects a best Action-Object with the highest summed probability;
a designator that assigns the best Action-Object to the electronic inquiry; and
a router that routes the electronic inquiry in accordance with the assigned Action-Object,
wherein when multiple salient terms are found, and/or multiple Action-Objects are linked to the salient terms, correct routing occurs.
